(19) United States
(12) Patent Application Publication
(10) Pub. No.: US 2026/0145235 A1
(43) Pub. Date: May 28, 2026

(54) A METHOD OF MANUFACTURING A 3D OBJECT, A 3D OBJECT AND A COMPUTER-READABLE MEDIUM

(71) Applicant: Alloyed Limited, Kidlington Oxfordshire (GB)

(72) Inventors: Rhys Jones, Oxford Oxfordshire (GB); Edward Speirs, London (GB); Sarat Babu, Essex (GB)

(73) Assignee: Alloyed Limited, Kidlington Oxfordshire (GB)

(21) Appl. No.: 19/102,817

(22) PCT Filed: Aug. 3, 2023
(86) PCT No.: PCT/GB2023/052054

§ 371 Date: Feb. 10, 2025

(30) Foreign Application Priority Data
Aug. 11, 2022 (GB) 2211743.6

(51) Int. Cl. B22F 10/28; B22F 10/364; B22F 10/38; B22F 10/39; B22F 10/50; B33Y 10/00; B33Y 40/00; B33Y 80/00

(52) U.S. Cl. CPC B22F 10/28; B22F 10/364; B22F 10/38; B22F 10/39; B22F 10/50; B33Y 10/00; B33Y 40/00; B33Y 80/00

(57) ABSTRACT

A method of manufacturing a 3D object, the method comprising: providing a powder layer of powder particles; building up a new layer of the 3D object by directing a beam of radiation towards the powder layer to melt the powder particles at predetermined positions to build up the new layer of the 3D object on re-solidification; and forming a pore in the new layer at a preselected position by using a beam of radiation to form and subsequently collapse a melt pool so as to trap gas as a pore in or below the new layer at the preselected position on re-solidification.

The present invention relates to a method of manufacturing a 3D object, a 3D object and a computer-readable medium.

3D printing of objects, particularly by laser powder bed fusion (LPBF) allows the formation of complex three dimensional objects, including three dimensional metal objects with complex shapes. In this process powder particles are laid down as a powder layer. Areas where the three dimensional object is to be present are irradiated with a beam of radiation (for example a laser beam, for example a ytterbium fibre laser beam). This radiation imparts enough energy to the powder particles to melt them as well as a portion of an underlying substrate (which could be a part of the 3D object manufactured in a previous step) and previously melted and solidified powder adjacent in the same layer, to build up solid material on re-solidification in a new layer. A new powder layer is then provided on top of the just solidified new layer and the process is repeated. In this way, by directing the laser at appropriate parts of the powder layer, complex shapes can be built up layer-by-layer, including complex shapes with internal voids. However, the minimum achievable size of such internal voids is quite large, for example of the order of a minimum of the spot size of the laser beam. Thus internal voids have a minimum volume equivalent to a sphere with a diameter of about 150 μm. Furthermore, because of the way in which laser powder bed fusion works, any such voids formed within the product would be filled with powder particles meaning that any reduction in density due to the presence of the void is limited.

WO 2021/212887 discloses a method for forming pores in straight lines in a single layer during 3D printing of an object. The laser scans the powder layers in first and second strip zones (zones over which the laser moves back and forth along parallel lines). The first and second strip zones are lap-joined to have a zone which overlaps. Due to the overlap the powder is first melted and solidified in the first zone before being re-melted in the overlap are whilst the second zone is scanned by the laser to melt the powder and allowing it to re-solidify in the majority of that zone (the non-overlapped portion). The laser energy is maintained constant and by controlling “the shaping process parameters to make the laser energy input twice superimposed in the strip lap-joint zone reach a predetermined energy value, keyholes will be formed in the strip lap-joint zone, thereby leaving pore defects”. That is, the time between the laser inputting energy at the location of a pore during scanning in the first zone and during scanning of the second zone is kept short so that the energy input at that location in the form of heat during frust scanning is not conducted away before the second time laser energy is input at that location during scanning of the second zone. A disadvantage of this system for making pores in an object is that it is only possible to create voids in a straight line in a one layer and the size of zones is limited by the need to keep the time interval between the first and second pass of the laser in the lap-joint zone short enough so that energy from the first laser scanning has not been conducted away so that energy from the second scanning is enough to form the keyhole required for formation of the pore. This latter limitation severely impacts through-put.

The present invention provides a way of manufacturing a 3D object in which a pore can be formed at a preselected position.

The present invention provides a method of manufacturing a 3D object, the method comprising: providing a powder layer of powder particles; building up a new layer of the 3D object by directing a beam of radiation towards the powder layer to melt the powder particles at predetermined positions to build up the new layer of the 3D object on re-solidification; and forming a pore in the new layer at a preselected position by using a beam of radiation to form and subsequently collapse a melt pool so as to trap gas as a pore in or below the new layer at the preselected position on re-solidification.

This method advantageously allows the positioning of one or more pores in a 3D object at a preselected position and of a size much smaller than achievable by forming a void using the positions in a layer that a laser is directed to during building up of a layer to form the void.

In an embodiment the forming a pore occurs during the building up step preferably such that the pore is formed when the powder particles are melted for the first time. This is advantageous as it reduces time to manufacture the object. This is further advantageous over the technique disclosed in WO 2021/212887 because careful programming of strip zones and lap-joint overlap is unnecessary and additionally because throughput is increased because each part of the layer only needs to be irradiated once.

In an embodiment the forming a pore occurs after at least a part of the building up step has occurred and the preselected position is in the already formed new layer and the pore is formed in the new layer. This is advantageous as it allows better control of the parameters used in the building step and in the forming a pore step. Additionally there is less constraint as to the positioning of the pore when the pore is formed in a separate step.

In an embodiment forming a pore occurs after the building step has occurred for the complete layer. This is advantageous as the new layer can then be built up in the most appropriate way without needing to make compromises in order to accommodate pore formation. For example, the building up a new layer step can be performed in the most time-efficient way or in the way which produces the best possible microstructure without needing to worry about the pore forming step. The pore forming step can then be carried out at any desired location and with any (e.g. laser) parameters. This total freedom means that the building up a new layer step and forming a pore step can both be optimised.

In an embodiment, in the forming a pore step, the preselected position is distant from an edge of the new layer. This is beneficial because the way in which the beam of radiation of the forming a pore step interacts with the new layer will be different near the edge of the new layer than at locations within the bulk of the new layer where the thermal transfer characteristics are constant. At the edge of the new layer, the thermal transfer characteristics are not consistent (e.g. there will be faster thermal transfer towards solid material than towards powder material), meaning that control of the pore forming step and the formation of pores is less consistent near edges of the new layer.

In an embodiment, the preselected position is at least 10 times a spot size of the beam of radiation from the edge of the new layer, preferably 20 times a spot size of the beam of radiation from the edge of the new layer. It is estimated that this minimum distance will ensure consistency in the forming pore step.

In an embodiment, the preselected position is other than in the middle of a scan line used for building the new layer. This means that the position in which the pore is formed is not determined in any way by the step of building up a new layer and is independent of the way in which the new layer is built up.

In an embodiment, a power of the beam of radiation used in the forming a pore step is greater than 300 W, preferably greater than 350 W and more preferably greater than 400 W and/or an exposure time of the beam of radiation used in the pore forming step is 40 ms or greater, preferably 100 ms or greater. Experimental results have shown that at these minimum power and/or exposure times keyholing occurs and can be used to form pores in a step separate from the building a new layer step.

In an embodiment the method further comprises providing a final powder layer of particles on the new layer and building up an outer layer of the 3D object by directing a beam of radiation towards the powder layer to melt the powder particles at predetermined positions to build up the outer layer of the 3D object on re-solidification. This may be advantageous as the pores are deeper within the 3D object and can be made invisible from the outer surface of the 3D object, even after post processing.

In an embodiment the preselected position is within a volume of the 3D object such that the pore is a closed cell. This allows the pores to be hidden from view.

In an embodiment the preselected position is on an outer surface of the 3D object. This allows the visual appearance of the object to be changed.

In an embodiment the pores are formed at a plurality of preselected positions during the forming a pore step by using the beam of radiation to form and subsequently collapse a melt pool so as to trap gas as a pore in the new layer at the plurality of preselected positions on re-solidification. In this way multiple pores can be used dramatically to change the properties of the object or provide considerable data within the object, which is readable non-destructively.

In an embodiment the preselected positions are selected such that the pores in the 3D object are open cells with at least one path through pores from one outer surface of the 3D object to another opposite outer surface of the 3D object. This allows the method to be used to make filters or wicking structures, for example, or objects with at least one portion of very low density compared to other locations.

In an embodiment in the forming a pore step the beam of radiation is focussed on a first area at the preselected position and transfers a first total amount of energy onto the first area and the first total amount of energy is greater than a second total amount of energy transferred to an area equal in area to the first area during the directing of the building up a new layer step. This is advantageous because it allows material in the re-solidified new layer to stabilise thermally before the forming a new pore step. If it is necessary to have a short time between melting powder and allowing the material to solidify, before forming the pore, there can be large variations in residual temperature of the solid layer from location to location prior to forming the pore and this can lead to inconsistent pore formation. Transferring more energy in the fore forming step than in the building a layer step means that the consistency of any pores formed in the forming a pore step is increased because the forming a pore step does not rely on energy imparted into the new layer during the building up step for the formation of the pore.

In an embodiment wherein the directing a beam of radiation in the building up step is different to the directing a beam of radiation in the forming a pore step by at least one of: power of beam of radiation, speed of movement of beam of radiation, duration of irradiation, spot size of beam of radiation, delay between bursts of the beam of radiation, wavelength of the beam of radiation, oscillation frequency of the beam of radiation, cross-sectional shape of the beam of radiation, focus depth of the beam of radiation. This is advantageous because the characteristics of the beam of radiation is tailored for new layer building or for formation of a pore and the parameters can be selected independently of each other.

In an embodiment the plurality of preselected positions are arranged to indicate manufacturing conditions of the 3D object. This is advantageous as information can be added permanently to the object during manufacture, for example in a way in which it cannot subsequently be altered without destroying the object or the object's functionality. The data may be hidden from view and only be readable to special machine (microCT). In an embodiment the plurality of preselected positions are arranged to represent one or more of: an alphanumeric character, an image of an object, a trademark. This would be particularly attractive as the information, once presented, could be understood by the layman.

In an embodiment a number of the plurality of preselected positions within a unit volume of the 3D object at a first location is different to a number of the plurality of preselected positions within a unit volume of the 3D object at a second location. This is advantageous as the properties of the object can be tuned from one location within the object to another.

In an embodiment the preselected positions are such that the 3D object has a sandwich structure in which two layers with a relatively low number of preselected positions within a unit volume are positioned on either side of a layer with a relatively higher number of preselected positions within a unit volume. A sandwich structure is known to have particularly desirable mechanical properties.

In an embodiment at least some of the plurality of preselected positions are proximal to a portion of an outer surface of the 3D object, and further comprising anodising the 3D object such that the portion of an outer surface has an anodising layer that is thinner than the anodising layer formed on the remainder of that outer surface. This is advantageous as the method can be used to alter the visual appearance of the 3D object.

In an embodiment the method further comprises preselecting the preselected positions such that at least one of: mechanical strength, density, resonant frequency, stiffness, elastic modulus, thermal conductivity, electrical conductivity of the 3D object varies from one portion of the 3D object to another in a controlled manner. This is particularly advantageous as these are properties which are particularly desirable and difficult to vary in an object in any other way whilst keeping the object monolithic.

In an embodiment the method further comprises a remelt pass prior to the forming a pore step, wherein during the remelt pass a beam of radiation is directed at the new layer to remelt the new layer and allow it to re-solidify. This is advantageous as this process can be used to reduce accidental porosity so that the pores in the finished product conform more closely to the preselected locations.

In an embodiment the present invention provides a 3D object comprised of a base material including a plurality of pores at preselected locations in the base material, wherein each of the plurality of pores has a volume equivalent to a sphere with a diameter in the range of 2 to 150 μm as measured by X-ray microCT under ISO 15708-3:2017, and has a density of less than 50% of the base material.

In an embodiment the present invention provides a computer-readable medium storing data which defines a digital layer-by-layer representation of a 3D object and locations of pores in those layers, and operating instructions adapted (i) to control an AM device to fabricate the 3D object in a layer-by-layer fashion using the digital representation of the 3D object, and (ii) to control the AM device to form pores in the 3D object by directing a beam of radiation to form and subsequently collapse a melt pool of material to trap gas as a pore on re-solidification at the locations of pores before formation of the next layer, when said data is relayed to the AM device.

The present invention will now be described by way of example only with reference to the following drawings in which:

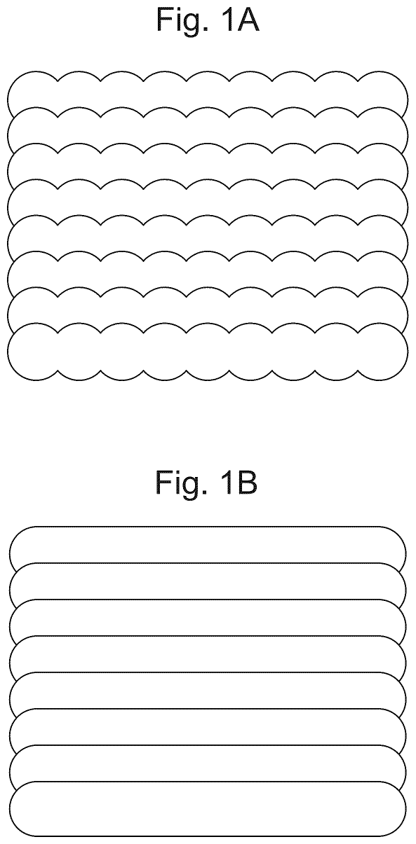

FIGS. 1A and 1B show in plan, patterns generated in LPBF for modulated and continuous radiation beam modulation respectively;

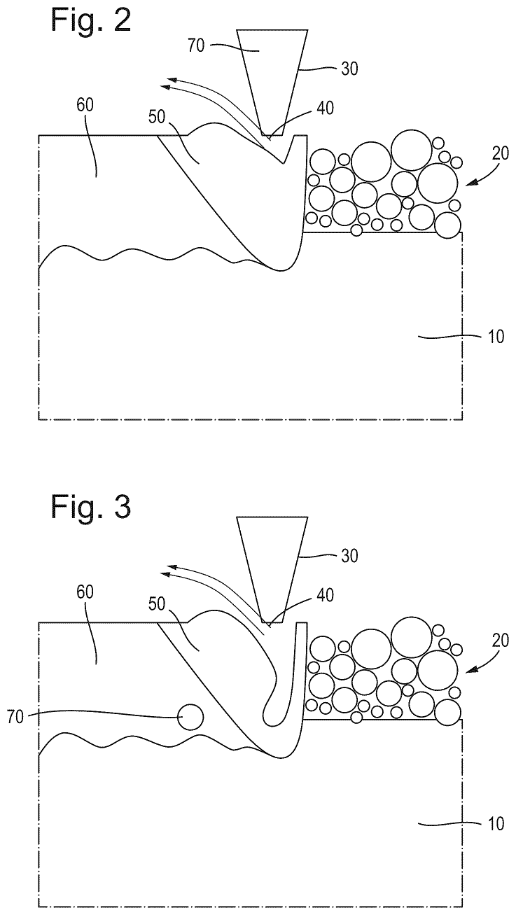

FIG. 2 is a schematic cross-sectional diagram of the method of a step of building up a new layer of a 3D object during laser powder bed fusion;

FIG. 3 is a schematic illustration of a step of forming a pore in the new layer;

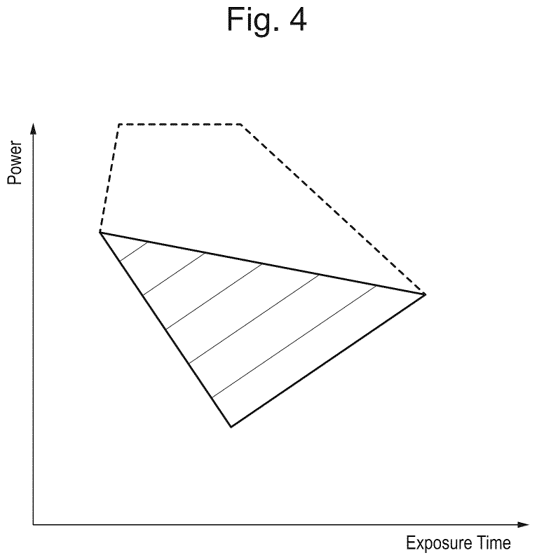

FIG. 4 is a schematic diagram illustrating how different phenomena are achieved during directing a beam of radiation towards a layer of powdered particles;

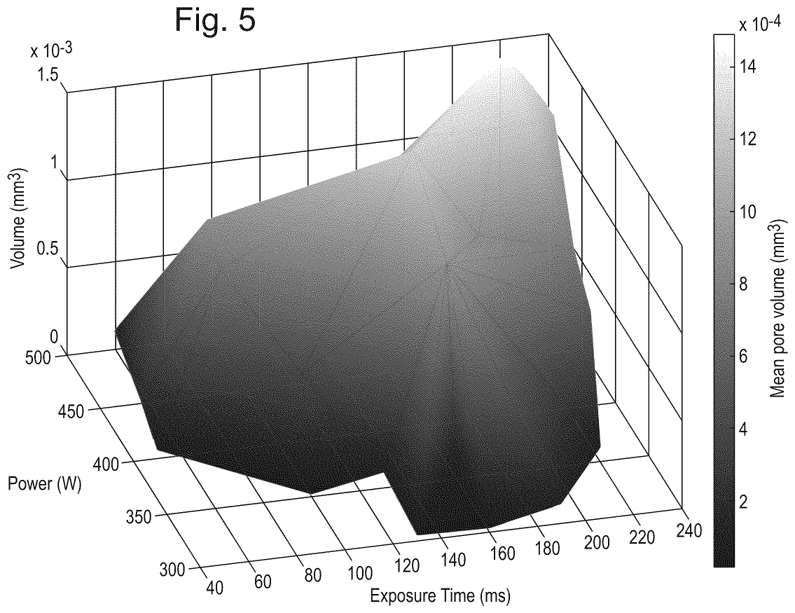

FIG. 5 is a graph illustrating the effect of laser power and exposure time on pore size;

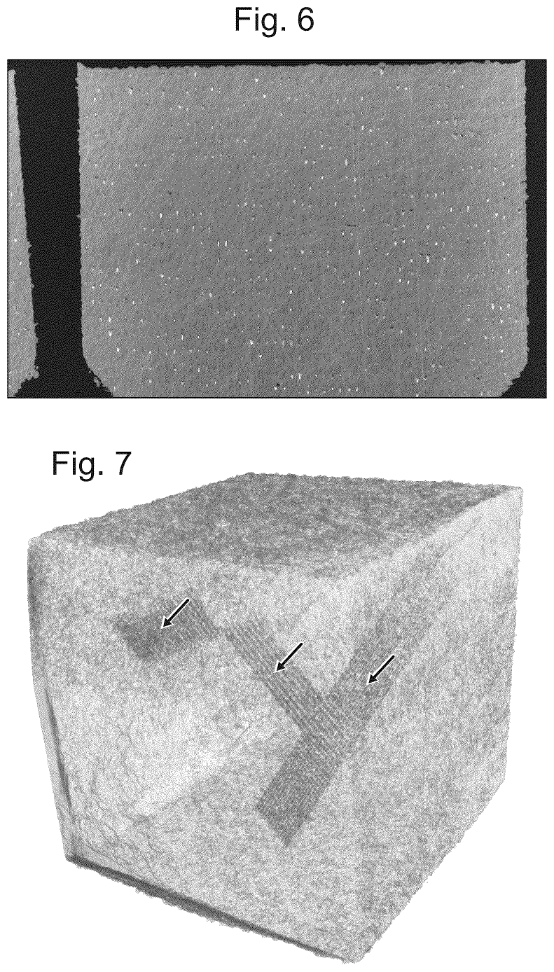

FIG. 6 is a cross-sectional micrograph of a sample created by laser powder bed fusion in which pores have been formed at preselected positions using different combinations of laser power and exposure time; and

FIG. 7 is a micro-CT scan of an object with pores formed at preselected positions to form a mark within the object.

The present invention will be described with reference to metal powder particles being used to form a metal 3D object. However, the invention is not limited to metal materials and the same principles apply to other materials such as plastics.

In powder bed fusion a 3D object is built up layer-by-layer. A layer of powder particles is provided in a so-called powder bed. A beam of radiation (for example a laser) is moved across the powder bed. Areas of the powder layer where solid is desired are melted and fused together by directing a beam of radiation towards the powder layer to melt the powder particles into a melt pool and then allowing the melt pool to solidify. Additionally, a top surface of an underlying substrate (which could be a previous layer generated in the same way) is also melted so that the melt pool extends into the layer beneath it. If the location is adjacent to a position which has already been melted and re-solidified, a portion of that area is melted again to form the melt pool so that the newly melted powder fuses with the already melted and re-solidified powder. This process carries on until all the powder particles are fused together in the areas where solid 3D object is desired in the layer. That completes building up of a new layer and the process of providing a new layer of powder particles and irradiating predetermined positions can be carried out again and again until the 3D object is formed.

The beam can be continuous or can be modulated. In a continuous mode, laser energy is delivered continuously to melt the powder by guiding the laser beam to and fro across the surface of the powder bed to solidify the metal. The scan lines overlap so that each successive part of the laser partly re-melts the previous scan line creating a solid mass of welded material. In modulated mode the laser is turned on and off and then moved before being turned on and off again creating a series of exposures. Each exposure partly overlaps with the previous one (as well as any adjacent areas which have already been melted and solidified). FIG. 1A shows such a melted pattern formed by points along a line and FIG. 1B shows a continuous pattern of exposed lines where a continuous beam of radiation is directed to the object and the object moved relative to the beam of radiation so that points along a line are exposed continuously. As the melting process moves down the page a new line along which the beam of radiation moves creates a melt pool which overlaps with the previous area melted in that same layer.

FIG. 2 shows in cross-section how a layer of powder 20 on top of a substrate 10 is melted using a beam of radiation 30. In this example, a continuous way of building up the object is shown in which the laser moves in adjacent lines over the powder bed in direction 32.

The beam of radiation 30 melts the powder particles 20 and a portion of the substrate 10 underlying the powder 20 form a melt pool 50. As the beam of radiation moves further in direction 32, a trailing edge of the melt pool 50 solidifies to leave a solidified portion of the new layer 60.

The beam of radiation 30 is controlled in order that the whole layer depth of powder 20 is melted as well as some of the underlying substrate 10. The beam of radiation 30 is also positioned on the powder layer such that a previous solidified line which is adjacent to the current line along which the beam of radiation moves is melted so that the melt pool 50 extends not only into the underlying substrate 10 but also into any solidified material adjacent (as shown in FIGS. 1A and 1B).

As can be seen in FIG. 2, during irradiation of the powder particles by the beam of radiation 30 a cavity 40 is produced in the melt pool. Such a cavity is formed of vapour (for example metal vapour). In normal processing the beam of radiation 30 is controlled such that the cavity 40 maintains a relatively small size whilst still generating a melt pool 50 which extends into the underlying substrate 10.

FIG. 3 illustrates a circumstance where the laser beam of radiation 30 creates a deeper cavity 40. In this circumstance, gas is trapped in the cavity 40 so that the melt pool collapses as the melt pool 50 solidifies resulting in a pore 70 being left in the re-solidified material 60 of the new layer. In usual laser powder bed fusion processes the formation of such pores (sometimes termed keyholing) is to be avoided and the beam of radiation 30 is controlled accordingly to minimise the accidental formation of pores 70 in random locations. The pore 70 is formed by over-melting. Such pores are often called keyhole pores. The gas within the pore is generally the shielding gas or the gas of the operating environment, for example argon. This is because any of the metal which vaporises to form the cavity 40 would obviously transform to liquid and then solid on cooling.

Generally when using laser powder bed fusion it is possible to achieve a density of greater than 99.9% of the alloy being used meaning that there are very few pores which are randomly dispersed through the part due to unwanted key holing. The present inventors have realised that the formation of pores by the mechanism shown in FIG. 3, namely by trapping gas in a melt pool 50 to form a pore 70 in the new layer 60 on re-solidification, can be purposefully forced to occur. This allows the positioning of one or more pores 70 at preselected positions within the 3D object. One way of achieving this is by varying the way in which the beam of radiation 30 is directed at the powder particles at the preselected positions.

As shown in FIGS. 2 and 3 during the building a layer step (FIG. 2) the depth of the melt pool 50 is less than the depth of the melt pool formed during pore formation (FIG. 3). FIG. 4 shows in the cross-hatched area power and exposure times suitable for building up a substantially pore free new layer of the 3D object in powder bed fusion (e.g. the process of FIG. 2). A typical range of powers for AlSi10Mg with a 30 μm powder layer thickness is about 200 to 500 W with an exposure time of 20-160 ms. For example an exposure power of 200 W would be applied for about 100 to 160 ms whereas an exposure power of 500 W would be applied for about 20 to 50 ms. For longer exposure times at lower power this can lead to a lack of fusion between particles of powder or between the new layer and the substrate or adjacent portions of the already formed new layer. For shorter exposure times at substantially higher power this can lead to balling up. This is where high surface tension of melted powder particles results in separation of the melt pool from solid material of the new layer thereby forming a large void. An appropriate set of conditions for pore formation (e.g. the FIG. 3 process) is at higher power and longer exposure times i.e. above the hatched area in FIG. 4. That is, the pore is formed by overexposure on the laser powder bed fusion system.

On the basis of this understanding the present inventors have devised that the previously undesirable pore formation due to excessive depths of the cavity 40 formed in the melt pool 50 can be deliberately forced to occur at preselected positions to form one or more pores on re-solidification, e.g. by trapping gas. The pore may be formed in the new layer just built up, or below the new layer, for example in a layer built up before the new layer, or in an underlying substrate. Indeed the method can be used on a pre-exiting solid object, not necessarily built up by additive manufacturing. That is, the method can be used to form pores just below the surface of a 3D solid object. In the pore forming step one or more pores may be formed from each melt pool formed. In some applications it may not be required to be able accurately to position or size every single pore and the mere presence of one or more pores of any size proximate to the preselected position suffices.

Thus, the pores formed by the method of the present invention are distinguished over pores which are accidentally formed by keyholing because keyholing is not controllable and happens at random. Therefore any pores formed by keyholing are not at pre-selected positions. Thus it is possible to produce two 3D objects with pores in locations which are substantially the same. On the other hand, when pores are only formed by random keyholing, no two 3D printed objects will have the same pattern of pores within them. The present invention allows pores to be formed at any location and with pores in any desired pattern including patterns which are not in straight lines (i.e. the pores are not only formed in overlap portions of strip zones as in WO2021/212887), due to the difference between the method of the present invention and the method of WO2021/212887. Thus greater flexibility in positioning of pores has been achieved. In an embodiment this is accomplished by controlling the parameters of the beam of radiation such that the amount of energy transferred onto a first area during forming a pore at that first area is greater than a second total amount of radiation transferred beforehand to that area during building up of a new layer (i.e. melting powder and allowing it to re-solidify to form a solid). In contrast, in WO2021/212887, the operating parameters of the laser are kept constant and enough energy to form a keyhole is only transferred to an area where a pore is to be formed due to the residual thermal energy remaining at that area from the initial melting of the powder step. Thus in WO2021/212887, pore formation is limited to overlap zones and through-put is limited because of the need to form pores quickly after the initial transformation of powder into solid material which means only small strip zones can be used, resulting in inefficient layer formation.

The steps of providing a powder layer and building up a new layer and optionally forming a pore can be repeated in that order a plurality of times. In the second and any subsequent recoating with powder step (aka providing a powder layer step), the powder layer is provided on the new layer of the preceding building up a new layer step, thereby to manufacture the 3D object in a layer-by-layer fashion.

Pore formation can be implemented during the building up of the new layer. That is, the pore can be deliberately formed when the powder particles are melted for the first time. Although this is possible, there are a few disadvantages. First, it is necessary to stop the movement of the beam of radiation over the powder bed, to switch mode (from continuous wave to modulated wave, should the building up of the new layer being performed in continuous mode), change the operating parameters of the laser beam to form the pore, and then switch back to the previous operating parameters of the beam of radiation. Furthermore, the size of the pore which can be formed is more limited because the melt pool needs to have a large enough diameter to fuse with the surrounding solid material, whilst also be optimised to generate the pore. It is difficult to optimise all of the competing parameters. However, such an approach has the advantage of increased through put as the workpiece does not need to be repositioned at the locations of the desired pores for irradiating those positions a second time. In an additional or alternative embodiment pore formation can occur after (part, or all of) the new layer has been built up. That is, the beam of radiation is directed at a preselected portion of the already re-solidified new layer, to form a new melt a pool 50 with a cavity 40 deep enough so as to trap gas as a pore 70 on re-solidification. This has the advantage that the parameters used to generate the beam of radiation can be optimised for the formation of the pore 70 without needing to consider fusion with surrounding material. A further advantage is that the pore can be formed at any preselected position and does not necessarily need to be in the middle of a scan line used for creating the new layer (that is the pore can be formed between two parallel scan lines and not necessarily only at a position along a scan line of the building up a new layer step).

For example, it has been found that creating a pore during building up the new layer results in a minimum pore width of 60 μm when the scan line width is between 150 and 250 μm. In contrast, when the pore is formed as a separate process by irradiating a beam of radiation on the already solidified new layer, pore sizes as small as 2 μm are possible. This size of pore is much smaller than that disclosed in WO 2021/212887 which only allows pores of about 25 μm to be formed. Therefore, it is particularly advantageous only to form pores after the building up step has occurred for the complete layer; this allows much better control of the forming a pore step as the process does not rely on the temperature of the new layer still being elevated as a result of the building up of that new layer in order for the beam of radiation of the forming a pore step to have enough energy to form a keyhole and therefore a pore. That is, the energy of the beam of radiation used in the building up a new layer step will have been conducted away by the solid new layer (and any underlying previously formed layers or substrate) meaning that fine control of the keyholing during the forming a pore step is possible. In this connection alternatively or additionally any pores are preferably formed at a position distal from an edge of the newly formed layer. That is, the pore is formed at a location surrounded by solid material (rather than powder), preferably on all sides. This means that the heat in the new layer where the pore is about to be formed will have been conducted away in all directions more evenly than at locations proximate an edge of the solid layer and the pore can be formed there in a more consistent way because the amount of energy needed is mainly imparted by the beam of radiation of the forming step and this can be controlled easily. It has been found that if the preselected position where the pore is formed is at least about 10 times, preferably 20 times the spot diameter of the beam of radiation used for building the new layer from the edge of the new layer that these advantages can be reliably realised.

The present inventors, using an unmodified Renishaw AM 500 additive manufacturing machine, formed pore size ranges using the above method of between 20-130 μm in AlSi10Mg. For example a 130 μm pore was formed with an exposure of 490 W for 170 ms whereas a pore of about 20 μm was formed with an exposure of 450 W for 50-70 ms. In stainless steel 316 L pore sizes ranging from 10 to 107 μm were made. Generally more stable pore formation is possible at lower exposure times and higher power. As the power and/or exposure time increases, pore size increases. If very high energy or very long exposure times are used, multiple pores are formed which are randomly dispersed near the target location. Thus the method has been shown for aluminium alloy and steels and it can be predicted that the same method can be used for other metals, including pure elemental metals and their alloys, including, but not limited to, aluminium and aluminium alloys, titanium and titanium alloys, steels, particularly stainless steels, nickel and nickel alloys, including superalloys, copper and copper alloys, platinum and platinum alloys, tantalum and tantalum alloys etc.. The method is also applicable to other materials which can be formed by additive manufacturing, in particular LPBF, including plastics materials.

The beam of radiation can be controlled to vary the depth of the melt pool formed and so whether or not a pore is formed and if a pore is formed the size of the pore. The depth of the melt pool can be varied in any way including but not limited to the power of the beam of radiation, the speed of movement of the beam of radiation over the powder bed, the duration of irradiation (exposure time), the spot size of the beam radiation, the delay between bursts of the beam of radiation, wavelength of the beam of radiation, oscillation frequency of the beam of radiation, cross-sectional shape of the beam of radiation, focus depth of the beam of radiation. Generally, but not exclusively, the beam of radiation during the forming the pore step is focused on an area at the pre-selected position and transfers a total amount of energy into the first area which is greater than a total amount of energy transferred to the same area during the directing of the radiation beam during the building up of a new layer. However, this is not necessarily the case because, for example, a beam of radiation could be used to pre-heat the pre-selected position before a beam of radiation is subsequently aimed at the pre-selected position to form the pore by forming a melt pool. However, there may be an advantage in using a beam of radiation which is more focused or which has a smaller cross-sectional area to form the pore so that less heat is transferred to the surrounding material. This could be advantageous as the heating would not affect the microstructure of the surrounding material so much and the position of formation of the pore can be more precisely controlled.

FIG. 5 is a graph of experimental results using an unmodified Renishaw AM 500 additive manufacturing machine to manufacture a AlSi10Mg object showing the effect of varying laser power and exposure time on pore volume (as measured using X-ray micro CT as described below). As can be seen, with increasing power and exposure time pore volume increases. Pores start to be formed above a minimum laser power and exposure time. As can be seen from FIG. 5, a pore can be formed in a pore forming step, which occurs after thermal energy from a building a new layer step from the solid material, with a power of 300 W or greater. Larger pores may be formed with increasing amounts of power, for example of 350 W or more or more preferably with a power of 400 W or more.

An exposure time of 40 ms or greater also results in pore formation and larger pores can be formed (and in practice more consistently) with an exposure time of 100 ms or greater. An exposure power of 200-300 W would preferably be used with an exposure time of 60-100 ms whereas an exposure power of 300-400 W would preferably be used with an exposure of 40-60 ms.

FIG. 6 is a cross-sectional micrograph of a sample (with some of the pores elongated due to the polishing method used), where a two dimensional grid of preselected positions can be made out. The parameters of laser power and exposure time are varied from preselected position to preselected position resulting in different pore sizes and in some cases no observable pores at all (though it is possible that some of the pores were formed outside of the plane of the cross-section and so are not visible in the micrograph and for this reason micro CT is the preferred way of measuring pores).

Such pores are smaller than internal cavities which can be deliberately formed in a 3D printed object. Furthermore, such cavities would contain powder particles and therefore have a pore density of more than 50% of the density of the solid metal of the metal of the metal powder particles. In contrast, pores formed by the method of the present invention will have a pore density of much less than 50% than that of the density of the solid metal of the metal powder particles.

The pore number density (i.e. number of pores per unit volume) may be at least 10 pores per 1 mm³. This compares to a pore density of much less than 10 pores per 1 mm³ in a typically 3D manufactured object (e.g. 0.4 pores per 1 mm³). Unintentional pores in a 3D manufactured object have a pore number density generally of the order of 1 pore per mm³ or less and a density of 99.9% of the bulk metal, or more.

The gas pores are visible and measurable non-destructively via micro-CT (as shown in FIG. 7 for example) or destructively via sectioning the sample and polishing (for example FIG. 6).

The volume equivalent to a sphere of the pore can be measured by X-ray micro CT. ISO 15708-3:2017 provides a standard way of measuring volume equivalent using X-ray micro-CT. Pore size measurement is carried out on a Phoenix V|tome|x M (NF tube) at 120 kV and 160 μA with a 334 ms exposure time, with a 10 mm cube geometry. The detector is a temperature stabilised, dynamic detector of 410×410 mm, conforming to ASTM E 2597. 3600 projections were taken across a full 360° rotation, integrated over 4 hours and a voxel size of 4.8 μm was used. The parameters for measurement can be varied, in particular the voxel size, if, for example, smaller pore sizes are to be measured. In one embodiment pores with a volume equivalent to a sphere with a diameter in the range of 2-150 μm are present, preferably between 5 and 150 μm and more desirably between 10 and 130 μm.

Laser powder bed fusion processes do sometimes involve directing a beam of radiation at a newly built up layer. This can be done to increase density or improve surface finish for example. An example of this is so-called “upskinning” where surfaces of the 3D object exposed to a consumer are re-melted with a laser in a certain pattern (for example hatches where lines are rotated by 120° to each other) to improve the surface finish (e.g. improve surface roughness or even heal subsurface porosity). One, two, three, four or even more additional passes are used in such a process. In another technique, re-scanning of a built-up new layer with a beam of radiation can reduce subsurface porosity. However in each of these cases any melt pool generated will be small to avoid the possibility of in fact reducing the quality of the surface finish or increasing porosity. The upskinning/rescan may be a remelt pass and may be used in combination with the present invention. They may occur before or after the forming a pore step. The remelt pass will form a cavity and melt pool which penetrates less far into the new layer than the cavity and melt pool generated during the pore forming step.

Upskins and rescans occur at least once and up to 4 times over the desired solid area of the 3D object. Each of those upskins/rescans covers specific areas where defects have been found systematically to occur and/or areas at or close to a portion which will be surface in the finished product, to improve surface finish. The formation of pores according to the present invention is likely to occur by irradiating a total area with the beam of radiation which is smaller by a factor of 1 if not by a factor of 2, than a total area irradiated by the beam of radiation during the building up a new layer step. The preselected positions are discrete points, optionally only within the bulk of the object.

Some re-melting processes only re-melt borders of solid parts of a new layer which will form the outer portions of the finished 3D product. The present invention is distinguished over those in that the irradiation to form pores occurs in what will be distal from the outer surface of the product so that the irradiation beam irradiates distant from an edge of the solidified new layer, including a small distance resulting in pores at a depth which could be exposed by a standard polishing post-additive manufacturing step.

The present invention is ideally suited to forming pores within the final 3D object (as opposed to in the outer surface), but is not limited thereto. If a pore is formed within the final 3D object ideally a final powder layer of particles is provided on the new layer in which a pore has been formed and the final powder layer is then processed in the usual way to build up an outer layer of the 3D object without any pores being formed in it thereby burying any preformed pores even deeper within the object. In that case the pore is a closed pore. However, the present invention can be used to form a pore in the outer surface of the 3D object and this may be desired for certain types of objects such as a 3D printed filter. The process can be used to create open pores with at least one (tortuous) path through pores from one outer surface of the 3D object to another opposite outer surface of the 3D object. Such a product could be a filter. A wicking structure could also be formed by forming pores along a surface of a 3D object or through an object. Such microscale porous wicking structures can be used in vapour chambers to transport fluid within an additively manufactured vapour chamber.

The method described herein can be performed on existing laser powder bed fusion machines, for example on the machines offered by Renishaw such as the AM500. Such machines are simply programmed to irradiate a beam of radiation at certain positions of a powder bed under certain conditions (for example, power, time, movement speed etc.) and in a certain order before applying a further layer of powder particles and irradiating those powder particles as specified by the programming. Therefore the above-described method can be implemented on such a machine by loading appropriate instructions. Therefore, the present invention also comprises a computer-readable medium storing data which defines a digital layer-by-layer representation of a 3D object and locations of pores in those layers, and operating instructions adapted (i) to control an AM device to fabricate the 3D object in a layer-by-layer fashion using the digital representation of the 3D object (e.g. the building up a new layer step, and (ii) to control the AM device to form pores in the 3D object by directing a beam of radiation to form and subsequently collapse a melt pool of material to trap gas as a pore on re-solidification at the locations of pores before formation of the next layer, when said data is relayed to the AM device.

As will be apparent, a 3D object can be produced by the described method in which pores are formed at a plurality of pre-selected positions. The pores may be formed in any desired combination of location and size. For example, the pores could be formed in a positional regular 1D, 2D or 3D array or a regular pattern or an irregular array or an irregular pattern depending upon the desired characteristics the pores impart on the 3D object. Because the pores can be formed anywhere within the 3D object they can be formed at locations where they are not visible from the outside of the 3D object. Therefore, information can be included within the 3D object in the form of the pores and that information is not visible to the naked eye without destroying the object (but the information can be read by, for example, micro-CT). This could be useful, for example, to indicate manufacturing conditions of the 3D object. The pores may be arranged to identify a manufacturer, identify a designer or an owner or identify any other information connected or not connected to the object. The pores may form a readable alphanumeric character or an image or even a trademark. One implementation is shown in FIG. 7 where a stylised character A is shown to have been formed by pores in several different layers (the alphanumeric character is formed at an angle to the direction of build up during laser powder bed fusion additive manufacturing). Similar arrangements of pores may be particularly attractive for jewellery or watches or other objects where a hidden hallmark or watermark is desirable.

The techniques described herein may be used deliberately to tune characteristics (e.g. mechanical, electrical, thermal, optical etc.) of a 3D object. Examples might be to vary the density of an object from one location to another location. That is, the number of the plurality of pre-selected positions of pores within a unit volume of the 3D object at a first location can be different to a number of the plurality of pre-selected positions of pores with a unit volume of the 3D object at a second location. In this way the overall weight of an object can be decreased but locations where high strength or stiffness of the object is required can have a lower porosity than other areas where a higher porosity can be used.

Increased porosity could be used to increase impact absorption of the 3D object or at least part of the 3D object.

One type of object where this might be useful is an orthopaedic implant. Such an orthopaedic implant with tailored mechanical properties can reduce elastic modulus to eliminate and/or reduce stress shielding. Another use of the same technique may be to minimise resonant frequencies within the object which could otherwise lead to high-cycle fatigue and other problems. This could involve having areas of different densities of pores or having a uniform density of pores throughout the object. The variation in properties could be achieved at least in part by varying the size of the pores from location to location. The pores may be anisotropically spaced within the 3D object such that an anisotropic variation of properties throughout the object can be achieved.

Providing pores in an object could be desirable to vary one or more of: mechanical strength, density, resonant frequency, stiffness, elastic modulus, thermal conductivity, electrical conductivity of the 3D object. Those properties could be varied from the properties of the bulk material uniformly throughout the 3D object or could be varied non-uniformly (e.g. anisotropically and/or non-homogenously) throughout the 3D object. For example, locations which require different properties can have the number of pores and/or sizes of pores in those different areas selected accordingly. Thus, during design of the data file used by the laser powder fusion apparatus, the designer can pre-select the positions to place the pores in the required locations to achieve the required variations in property.

Another example use of the invention may be to provide pores proximal to (but distal from) a portion of an outer surface of the 3D object. This is effective to change the electrical conductivity and thereby a pattern could be revealed on the surface of the 3D object by an electro-finishing process such as anodising. That is, areas with pores close to the surface have a lower conductivity meaning that during anodising, the anodising layer (oxide) would be thinner or even non-existent at such areas compares to areas free of pores close to the surface. Alternatively polishing the surface of the 3D object by chemical polishing or by abrasive polishing with an abrasive (including CNC machining) could also reveal the pattern of pores. In this way, the object will have a different appearance where pores are present than where pores are not present.

The pores could be positioned so that they are grouped in one or more layers in the object with layers on either side with no pores (or fewer or smaller pores) formed therein herein. In this way a sandwich structure can be created which is useful in terms of providing a lightweight structural component which has improved stiffness for its weight or in terms of providing a component with anisotropic properties, for example for promoting heat transfer in a particular direction. A heat sink can thereby be formed. Such closed cell foams can be used to control heat dissipation (insulation) within a component. Increased porosity will reduce the thermal conductivity in the area of increased porosity and therefore this technique can be used to direct heat away from certain locations. For example, it could be possible to ensure cosmetic surfaces stay cool to the touch in housings, for example for housings for electronics applications.

Once the 3D object has been printed, further treatment of the object can be carried out prior to the object being finished and ready for the consumer. Further processing may include surface treating a portion of an outer surface of the 3D object in any way including mechanically, chemically and thermally. The whole of the 3D object may be heat treated in such ways. The surface of the 3D object may be machined, for example so that it conforms more closely to the desired finished geometry or to improve the surface finish.

The 3D object may be coated, for example it may be anodised or galvanised or coated with a layer in any other way. The outer surface of the 3D object may be irradiated with a beam of radiation. The 3D object may be electro-machined or abrasively or electro-polished. The 3D object may be also undergo hot isostatic pressing (HIP).

It is possible to tell from the microstructure of a 3D printed object that it has been 3D printed. This is because when the melt pool solidifies, directional cooling takes place so that grains tend to grow in the direction towards the centre of the melt pool and in the case of continuous mode in the direction of laser movement. Therefore, by taking a cross-section of the 3D object and appropriately etching to reveal grain structure, it is possible to determine that the 3D object has been formed by 3D printing.

This process achieves a narrow distribution of pore sizes, if desired. Control over pore size is also possible by controlling the depth of the cavity produced within the melt pool (which is related to the depth of the melt pool produced).

1-44. (canceled)

45. A method of manufacturing a 3D object, the method comprising:
providing a powder layer of powder particles;
building up a new layer of the 3D object by directing a beam of radiation towards the powder layer to melt the powder particles at predetermined positions to build up the new layer of the 3D object on re-solidification; and
forming a pore in the new layer at a preselected position by using a beam of radiation to form and subsequently collapse a melt pool so as to trap gas as a pore in or below the new layer at the preselected position on re-solidification.

46. The method of claim 45,
wherein the forming a pore occurs during the building up step such that the pore is formed when the powder particles are melted for the first time.

47. The method of claim 45,
wherein the forming a pore occurs after at least a part of the building up step has occurred and the preselected position is in the already formed new layer and the pore is formed in the new layer.

48. The method of claim 47, wherein in the forming a pore step, the preselected position is distant from an edge of the new layer.

49. The method of claim 48, wherein the preselected position is at least 10 times the spot diameter of the beam of radiation from the edge of the new layer, preferably at least 20 times a spot diameter of the beam of radiation from the edge of the new layer.

50. The method of claim 45, wherein the preselected position is other than in the middle of a scan line used for building the new layer.

60. The method of claim 45, wherein a power of the beam of radiation used in the forming a pore step is greater than 300 W, preferably greater than 350 W, more preferably greater than 400 W and/or an exposure time of the beam of radiation used in the forming a pore step is 40 ms or greater, preferably 100 ms or greater.

61. The method of claims 45, further comprising:
providing a final powder layer of particles on the new layer and building up an outer layer of the 3D object by directing a beam of radiation towards the powder layer to melt the powder particles at predetermined positions to build up the outer layer of the 3D object on re-solidification.

62. The method of claim 45, wherein in the forming a pore step a depth of the melt pool is greater than a depth of a melt pool formed during the building a layer step.

63. The method of claim 45, wherein in the forming a pore step the beam of radiation is focussed on a first area at the preselected position and transfers a first total amount of energy onto the first area and the first total amount of energy is greater than a second total amount of energy transferred to an area equal in area to the first area during the directing of the building up a new layer step.

64. The method of claim 45, wherein the directing a beam of radiation in the building up step is different to the directing a beam of radiation in the forming a pore step by at least one of: power of beam of radiation, speed of movement of beam of radiation, duration of irradiation, spot size of beam of radiation, delay between bursts of the beam of radiation, wavelength of the beam of radiation, oscillation frequency of the beam of radiation, cross-sectional shape of the beam of radiation, focus depth of the beam of radiation.

65. The method of claim 45, wherein the preselected position is within a volume of the 3D object such that the pore is a closed cell.

66. The method of claim 45, wherein the preselected position is on an outer surface of the 3D object.

67. The method of claim 45, wherein pores are formed at a plurality of preselected positions during the forming a pore step by using the beam of radiation to form and subsequently collapse a melt pool so as to trap gas as a pore in the new layer at the plurality of preselected positions on re-solidification.

68. The method of claim 67, wherein the preselected positions are selected such that the pores in the 3D object are open cells with at least one path through pores from one outer surface of the 3D object to another opposite outer surface of the 3D object.

69. The method of claim 67, wherein the plurality of preselected positions are arranged to indicate manufacturing conditions of the 3D object.

70. The method of claim 67, wherein the plurality of preselected positions are arranged to represent one or more of: an alphanumeric character, an image of an object, a trademark.

71. The method of claim 67, wherein a number of the plurality of preselected positions within a unit volume of the 3D object at a first location is different to a number of the plurality of preselected positions within a unit volume of the 3D object at a second location, wherein the preselected positions are such that the 3D object has a sandwich structure in which two layers with a relatively low number of preselected positions within a unit volume are positioned on either side of a layer with a relatively higher number of preselected positions within a unit volume.

72. The method of claim 45, wherein the building and forming steps are conducted in a shielding gas atmosphere of an inert gas to reduce oxidation and such that the pore is filled with said inert gas.

73. A first 3D object comprised of a base material including a plurality of pores at preselected locations in the base material, wherein each of the plurality of pores has a volume equivalent to a sphere with a diameter in the range of 2 to 150 μm as measured by X-ray microCT under ISO 15708-3:2017, and has a density of less than 50% of the base material and a second 3D object comprised of a base material including a plurality of pores at preselected locations in the base material, wherein each of the plurality of pores has a volume equivalent to a sphere with a diameter in the range of 2 to 150 μm as measured by X-ray microCT under ISO 15708-3:2017, and has a density of less than 50% of the base material, wherein the preselected locations in the first and second 3D objects are substantially the same.
